(19) United States
(12) Patent Application Publication
(10) Pub. No.: US 2007/0262119 A1
(43) Pub. Date: Nov. 15, 2007

(54) WIRE BONDING PROCESS FOR INSULATED WIRES

(76) Inventors: Malliah Ramkumar, Singapore (SG); Loon Aik Lim, Singapore (SG); Charles J. Vath III, Singapore (SG); Christopher Carr, Markham (CA); Robert Lyn, Markham, Ontario (CA); John Persic, Markham (CA); Young-Kyu Song, Markham (CA)

Correspondence Address: OSTROLENK FABER GERB & SOFFEN, 1180 AVENUE OF THE AMERICAS, NEW YORK, NY, 100368403, US

(21) Appl. No.: 11/744,521

(22) Filed: May 4, 2007

Related U.S. Application Data
(60) Provisional application No. 60/799,056, filed on May 9, 2006.

(51) Int. Cl. A47J 36/02

(52) U.S. Cl. 228/101

(57) ABSTRACT

A process for bonding insulated wires is provided wherein a conforming free air ball is formed from an insulated wire to create a ball bond. A tip of the insulated wire is first positioned close to an electronic flame-off device and a first electric discharge is produced from the electronic flame-off device to melt the tip of the insulated wire and produce a pilot ball. The electric discharge is then terminated. A second electric discharge is then generated to produce the conforming free air ball, and thereafter, the conforming free air ball is attached to a bonding surface to create the ball bond.

### CROSS REFERENCE TO RELATED APPLICATION

This application claims the benefit and priority of U.S. Provisional Application Ser. No. 60/799,056 filed May 9, 2006, and entitled WIRE BONDING PROCESS FOR INSULATED WIRES, the disclosure of which is incorporated herein by reference.

### FIELD OF THE INVENTION

The invention relates to the bonding of fine wires to electronic components, and in particular to the bonding of wires comprising insulating or non-conductive material on their surfaces.

### BACKGROUND AND PRIOR ART

Wire bonding is a commonly-used and effective method of making electrical connections between semiconductor chips and the leads on lead frame carriers on which the chips are mounted. Wire bonding methods include thermal compression, ultrasonic and pulse bonding. The wires used are typically made of conductive materials such as gold, aluminum or copper.

The semiconductor industry has continually moved towards greater miniaturization of electronic packaging, components and modules as well as increasing their functionality. Therefore, with more densely-packed semiconductor chips, very fine wires are utilized to electrically connect bonding pads of the chips to the electrical conductors of substrates by wire bonding.

It has therefore become increasingly challenging to bond these fine wires to electrical contacts due to the smaller area within which to work. Furthermore, the densely-packed semiconductor chips lead to the gaps between adjacent wires being reduced, which in turn increases the risk of short circuits occurring when adjacent wires contact one another. One way to avoid short circuits is to take care to increase the gaps between wires, but that is not always a viable or efficient approach where components are densely packed.

A wire bonding process cycle is generally commenced by creating a free-air-ball (“FAB”) at the tip of the bonding wire that has a spherical shape. FIG. 1 is a side view of a FAB 108 formed from non-insulated gold wire 100 using a prior art electronic flame-off (“EFO”) sparking process. An end tail 102 of the gold wire 100 extends from the tip of a capillary (not shown) and is positioned close to an EFO electrode 106. FAB formation begins with an electric discharge or spark 104 from the EFO electrode 106 that heats up and melts the end tail 102 of the bonding wire 100 that extends below the capillary. Surface tension causes the melted end tail 102 of the bonding wire 100 to form a spherical shape and advance up the wire tail as more material melts. This creates the FAB 108. Once the spark 104 is terminated, the FAB 108 almost instantaneously solidifies. The FAB 108 is then pressed by the capillary to a bonding pad at a first bond position to form the first ball bond by applying adequate amounts of pressure, heat and ultrasonic motion for a certain time.

After the ball bond is formed, the capillary rises and travels to a second bond position while bonding wire 100 is fed out through the end of the capillary. Once the loop is formed between the first bond position and the second bond position, the capillary presses the wire 100 against the bonding pad to produce the second (or stitch) bond, again by applying adequate amounts of pressure, heat and ultrasonic motion for a certain time. After the second (or stitch) bond has been formed, the capillary rises to a prescribed height while feeding out wire to create another end tail. Then the bonding wire 100 is broken from the second bond, leaving sufficient end tail wire 102 for the formation of the next FAB 108.

FIG. 2 is a graphical illustration of a conventional standard EFO sparking profile represented by variation in a discharge current over time. The standard firing discharge consists generally of a discharge current I₁ that is maintained for a duration t₀-t₁. This should allow for sufficient heat and time to melt the wire 100 and create a conforming FAB 108. Thus, the conventional method for non-insulated or bare bonding wire uses an EFO electrode to fire a single electric discharge or high voltage spark to form the bonding ball. The general EFO mechanism inputs during the sparking are current, time and discharge gap. In case there are any disruptions to the input/output readings, the system would usually have the capability to detect that there is an error and eventually if it cannot correct itself, it interrupts the bonding process.

Insulated wires typically comprise an underlying conductive core metal material, such as gold, and an insulating layer, such as polyimide, to make the surface of the wire non-conductive. The introduction of insulated bonding wire technology allows for high density packaging and high input/output functionality by allowing the bonding wires to touch or cross without creating short circuits. However, the miniaturization of electronic packaging using insulated bonding wire introduces a new problem of the insulating material tending to impede electrical conductivity at the interface between the bonded wire and the bonding pad. As the presence of insulating material acts as a contaminant in making a reliable interconnection, there is a need to remove insulating material and expose the underlying conductive material when forming each wire bond to ensure that conductivity is not compromised. This pushes the limits of high volume manufacturing equipment and processes, particularly the wire bonding equipment performance. There is accordingly a need to devise methods to effectively remove insulating material from the wire surface at the bonding interface between the wire and the bond pad.

An example of a method of removing insulating material from insulated wire during the bonding process is described in US Patent Publication No. 2005/0045692A1 entitled “Wirebonding Insulated Wire and Capillary Therefor”. A method of bonding an insulated wire is described therein for electrically connecting a first bonding pad to a second bonding pad wherein a tip of a capillary holder holding the bond wire is moved over the surface of the second bonding pad such that the bond wire is rubbed between the capillary tip and the second bonding pad. This tears the bond wire's insulating material so that at least a portion of a metal core of the wire contacts the second bonding pad. The wire is then bonded to the second bond pad using thermocompression bonding. A disadvantage of this approach to mechanically remove the insulating material through frictional force is that rubbing the capillary tip prior to actual bonding increases cycle time. In turn, the corresponding advantage in terms of increased conductivity might not be significant. Furthermore, although it is applicable to removing insulating material prior to making a second bond, it is not applicable to a first ball bond wherein only an end tail of the bond wire protrudes from the capillary tip and an FAB has to be formed from the end tail. As such, mechanical rubbing of the end tail is inapplicable.

FIG. 3 is a side view of a FAB 18 formed from insulated gold wire 10 using the prior art EFO sparking process, which applies the sparking profile shown in FIG. 2. The insulated gold wire 10 with an end tail 12 is positioned close to an EFO electrode 16 and a spark 14 is generated to melt the end tail 12 of the wire 10 to form a FAB 18. Certain insulating material will have a tendency to result in a FAB 18 that is still substantially covered with an insulating layer 20 around the surface of the spherical ball. Some clean core material 22 may be observed at the base of the FAB, or distributed in patches around the surface of the insulating layer 20. This phenomenon is undesirable for forming a ball bond with high conductivity at the interface between the ball bond and the bonding pad.

It has been observed that formation of such undesirable FABs 18 when using insulated bonding wire during EFO is more common than when using non-insulated or bare wire. It has been also observed that for insulated bonding wire, the current EFO process may also tend to yield small, somewhat deformed balls. Therefore, the problem is that a conventional sparking process increases the chances of producing a FAB contaminated by an insulating layer (as shown in FIG. 3) or a non-spherical deformed FAB, which may all be generally referred to as non-conforming FABs. Deformed FABs may result in misshaped bonds that can cause electrical short to an adjacent ball bond and potentially cause an instantaneous bond failure or a weak ball bond. Hence, they can cause the microelectronic device to fail. Moreover, contamination from the insulating material not only can cause non-conforming FABs but can also contaminate the capillaries and even the EFO mechanism. The progressive accumulation of coating residue on the capillary orifice for receiving the bonding wire and on the EFO device over time can also contribute to inconsistent FAB formation.

Nevertheless, it has been observed that in many instances, it is still possible to form an acceptable FAB with some residual insulating material that can create a strong ball bond. When the insulated bonding wire tail end is subjected to heat caused by the electric discharge or spark, the melted part forms a ball. As the ball is forming, sometimes the coating splits into uniform stripes on the upper hemisphere of the ball, forming a so-called water melon pattern. In this case, as long the coating or insulating material does not obstruct the lower hemisphere a strong ball bond can be formed. However, the occurrence of such water melon patterns is unpredictable and it would not be prudent to count on there being sufficient contact between the underlying conductive metal to the bonding pad to form a strong bond caused by such coating splits.

To resolve the issues found with the application of conventional EFO processes to insulated bonding wire, appropriate modifications or enhancements to the EFO mechanism would be desirable to produce clean FABs and bring the FABs to the required volume to repeatably obtain reliable ball bonds.

### SUMMARY OF THE INVENTION

It is thus an object of the invention to implement a fast and effective method of bonding insulated wire that produces a ball with a cleaner exposed core metal for bonding.

Accordingly, the invention provides a method for forming a conforming free air ball from an insulated wire to create a ball bond, comprising the steps of: positioning a tip of the insulated wire close to an electronic flame-off device; producing a first electric discharge from the electronic flame-off device to melt the tip of the insulated wire and produce a pilot ball, then terminating the electric discharge; producing a second electric discharge to produce the conforming free air ball; and thereafter attaching the conforming free air ball to a bonding surface to create the ball bond.

It would be convenient hereinafter to describe the invention in greater detail by reference to the accompanying drawings which illustrate preferred embodiments of the invention. The particularity of the drawings and the related description is not to be understood as superseding the generality of the broad identification of the invention as defined by the claims.

### BRIEF DESCRIPTION OF THE DRAWINGS

An example of a preferred embodiment of a wire bonding process in accordance with the invention will now be described with reference to the accompanying drawings, in which:

FIG. 1 is a side view of a FAB formed from non-insulated gold wire using a prior art EFO sparking process;

FIG. 2 is a graphical illustration of a conventional standard EFO sparking profile represented by variation in a discharge current over time;

FIG. 3 is a side view of a FAB formed from insulated gold wire using the prior art EFO sparking process;

FIG. 4 is a side view of a pilot FAB formed after a first spark using an EFO sparking process according to the preferred embodiment of the invention;

FIG. 5 is a side view of a FAB formed after a second spark using the EFO sparking process according to the preferred embodiment of the invention; and

FIG. 6 is a graphical illustration of an EFO sparking profile represented by variation in a discharge current over time according to the preferred embodiment of the invention.

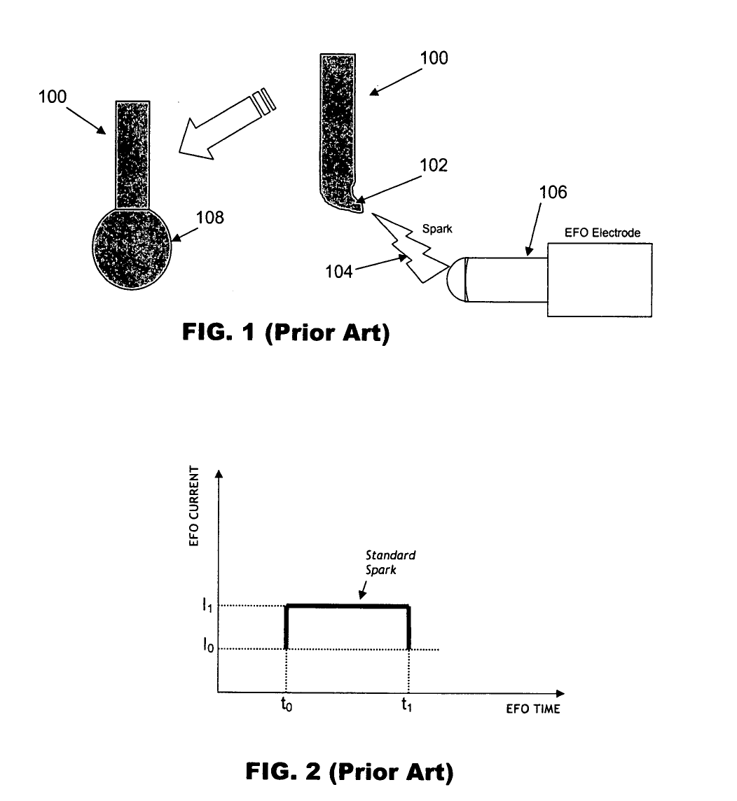

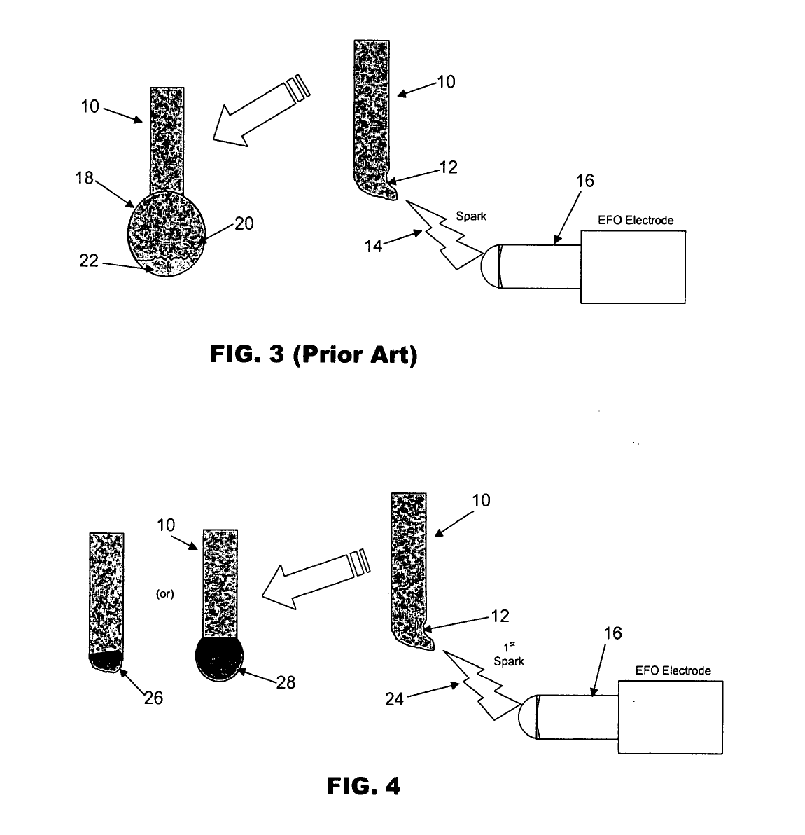

### DETAILED DESCRIPTION OF THE PREFERRED EMBODIMENT OF THE INVENTION

The preferred embodiment of the invention includes the use of two separate sparks to form a FAB at the tip of an insulated wire. FIG. 4 is a side view of a pilot ball formed after a first spark using an EFO sparking process according to the preferred embodiment of the invention.

To create the pilot ball, an end tail 12 of an insulated wire 10 is made to extend from a tip of a capillary (not shown) and is positioned close to an EFO device comprising an EFO electrode 16. The sparking process begins with an electric discharge or spark 24 from the EFO electrode 16 that heats up and melts the end tail 12 of the bonding wire 10 that extends below the capillary. This first spark 24 is preferably controlled to form the pilot ball in the form of a pre-melt 26 or a small ball 28 with a smaller volume than the final required FAB for forming a ball bond.

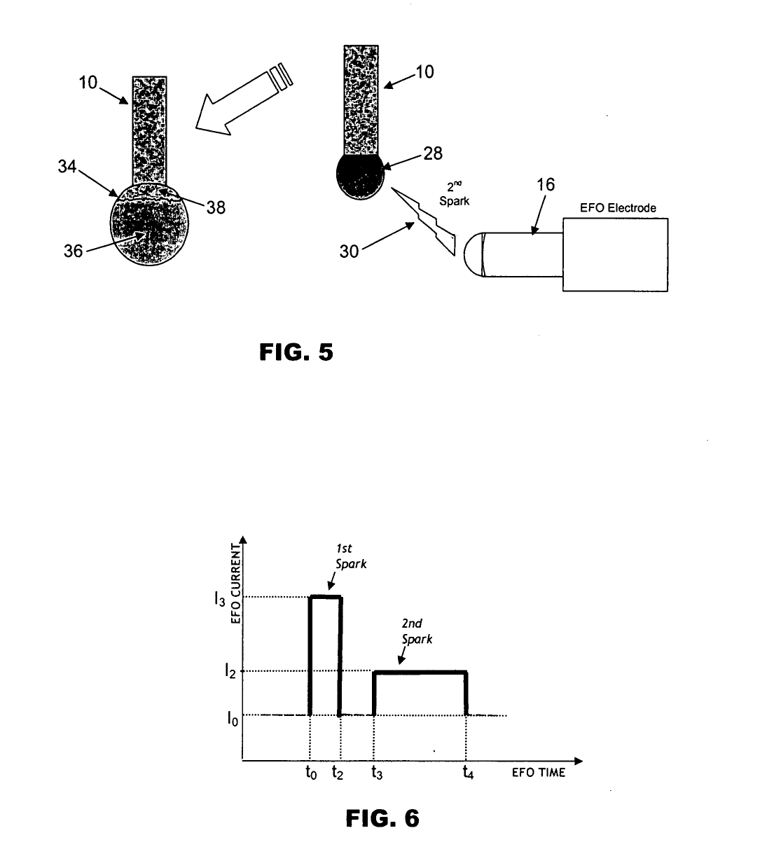

FIG. 5 is a side view of a FAB 34 formed after a second spark 30 using the EFO sparking process according to the preferred embodiment of the invention. After terminating the first spark 24, the pre-melt 26 or small ball 28 is preferably held at the same position and a second spark 30 is generated from the EFO electrode 16. The pre-melt 26 or small ball 28 formed after the first spark 24 is melted further by the second spark 30 until a conforming FAB 34 of a desired size and shape is formed. Upon examination, the FAB 34 appears to comprise substantially of a clean core metal 36 and the insulating layer 38 has receded to cover only a top portion of the FAB 34. This FAB 34 is of conforming shape and promotes conductivity of the wire bond to be formed due to the large area of exposed core metal comprised in its surface.

FIG. 6 is a graphical illustration of an EFO sparking profile represented by variation in a discharge current over time according to the preferred embodiment of the invention. The profile is represented by the EFO Current (I) versus EFO Discharge Time (t) graph. The first spark 24 is generated at a current I₃ for a duration t₀-t₂. There is a delay from t₂-t₃ wherein the electric discharge is terminated. Thereafter, a second spark 30 is generated at another current I₂ for a duration t₃-t₄.

For the purpose of illustration only, the first current I₃ is shown as being greater than the second current I₂, but it should be appreciated that the second current I₂, may also be greater than or equal to the first current I₃. Since the size of the melted ball that is formed is dependent on the magnitude of the current and the duration of the spark, the parameters can be varied and controlled such that the pre-melt 26 or small ball 28 is smaller than the final conforming FAB 34 that is desired, and that the final clean FAB 34 produced is of the required size that is necessary to form the ball bond.

It is preferred that the current used to generate the first spark is between 1600 mA and 300 mA for between 100 μs and 1000 μs. The delay between the first and second sparks is preferably less than 30 ms. The current used to generate the second spark is preferably between 1800 mA and 3200 mA, which is generated for a duration of between 200 μs and 1000 μs. The exact current size and spark duration will depend on the wire diameter used and the targeted ball size. The above parameters would be most suitable for wires with diameters of 0.8 mils to 1.0 mil, and for forming FABs with ball sizes of about 40 μm to 55 μm in diameter.

The purpose of a second consecutive electric discharge or spark fired at the pilot ball by the EFO electrode is to repeatably form a clean ball that is ready for the first ball bond. It is also noted that the insulating layer 38 that still remains on the upper hemisphere of the FAB 34 will not obstruct the bonding process from producing a strong inter-metallic bond. Even where a non-conforming ball is contaminated on the bottom hemisphere, or a ball is not formed at all due to coating obstruction after the first spark 24, the second spark 30 would help to promote formation of a conforming FAB 34.

Through insulated bonding wire bonding trials, it has been observed that by firing a first electric discharge to form a pre-melt 26 or small ball 28 of reduced volume, and then firing a second electric discharge, the process yields more consistently clean FABS. If the pre-melt 26 or small ball 28 is clean, the ball will stay clean as a result of second spark 30. However, if the pre-melt 26 or small ball 28 is contaminated, the final FAB 34 that is formed is cleaner as a result of second spark 30.

Accordingly, in order to prevent wire bonding process stoppages due to formation of non-conforming FABs that are not acceptable for the formation of the first ball bond, logic changes to the EFO sparking process have been suggested.

Although logic modification is the primary enhancement and other hardware changes are generally not essential, however, other modifications to the electric circuit, as well as slight modifications to the EFO electrode design and better electrode material selection, may also be incorporated to operate the process in a high volume manufacturing environment.

The invention described herein is susceptible to variations, modifications and/or additions other than those specifically described and it is to be understood that the invention includes all such variations, modifications and/or additions which fall within the spirit and scope of the above description.

1. A method for forming a conforming free air ball from an insulated wire to create a ball bond, comprising the steps of:
positioning a tip of the insulated wire close to an electronic flame-off device;
producing a first electric discharge from the electronic flame-off device to melt the tip of the insulated wire and produce a pilot ball, then terminating the electric discharge;
producing a second electric discharge to produce the conforming free air ball; and thereafter attaching the conforming free air ball to a bonding surface to create the ball bond.

2. The method as claimed in claim 1, wherein the pilot ball has a smaller volume as compared to the conforming free air ball.

3. The method as claimed in claim 2, wherein the pilot ball is in the form of a pre-melt or a small ball.

4. The method as claimed in claim 1, wherein the conforming free air ball is of a spherical shape and comprises substantially of a conductive core metal material on its surface.

5. The method as claimed in claim 1, wherein the first electric discharge is generated with a current of 1600 mA-300 mA and the second electric discharge is generated with a current of 1800 mA-3200 mA.

6. The method as claimed in claim 5, wherein the first electric discharge is generated for a duration of 100 μs-1000 μs and the second electric discharge is generated for a duration of 200 μs-1000 μs.

7. The method as claimed in claim 5, wherein a delay between the termination of the first electric discharge and the production of the second electric discharge is less than 30 ms.

8. The method as claimed in claim 1, wherein the first electric discharge is generated with a greater current than the second electric discharge.

9. The method as claimed in claim 1, wherein the second electric discharge is generated with a greater current than the first electric discharge.

10. The method as claimed in claim 1, wherein the insulated wire comprises an insulating layer at its surface that causes the surface of the wire to be non-conductive.

11. The method as claimed in claim 10, wherein the insulating layer comprises polyimide.
